(19) United States
(12) Patent Application Publication
(10) Pub. No.: US 2009/0251603 A1
(43) Pub. Date: Oct. 8, 2009

(54) IMAGE PLAYBACK SYSTEM

(75) Inventors: Klaus BURKHARDT, Kraichtal (DE); Roland Geisler, Karlsruhe (DE); Andreas Kaercher, Weingarten (DE); Uwe Nagel, Karlsruhe (DE)

Correspondence Address: SUGHRUE MION, PLLC, 2100 PENNSYLVANIA AVENUE, N.W., SUITE 800, WASHINGTON, DC, 20037, US

(73) Assignee: EIZO GmbH, Karlsruhe (DE)

(21) Appl. No.: 12/436,520

(22) Filed: May 6, 2009

Related U.S. Application Data
(63) Continuation of application No. PCT/EP2007/061929, filed on Nov. 6, 2007.

(30) Foreign Application Priority Data
Nov. 6, 2006 (DE) 102006052214.1

(51) Int. Cl. H04N 7/00; H04N 5/44

(52) U.S. Cl. 348/552; 348/553; 348/E07.091; 348/E05.096

(57) ABSTRACT

An image playback system (3), to which digital R, G, B video signals (R, G, B), respectively via R, G, B line pairs (7, 8, 9), and a communication signal (SDA) may be supplied by an image source (1), includes a program memory (18) in which configuration data for a programmable module (21) are stored, said data being necessary for operation of the image playback system (3). The disclosed system improves how firmware is updated for the image playback system.

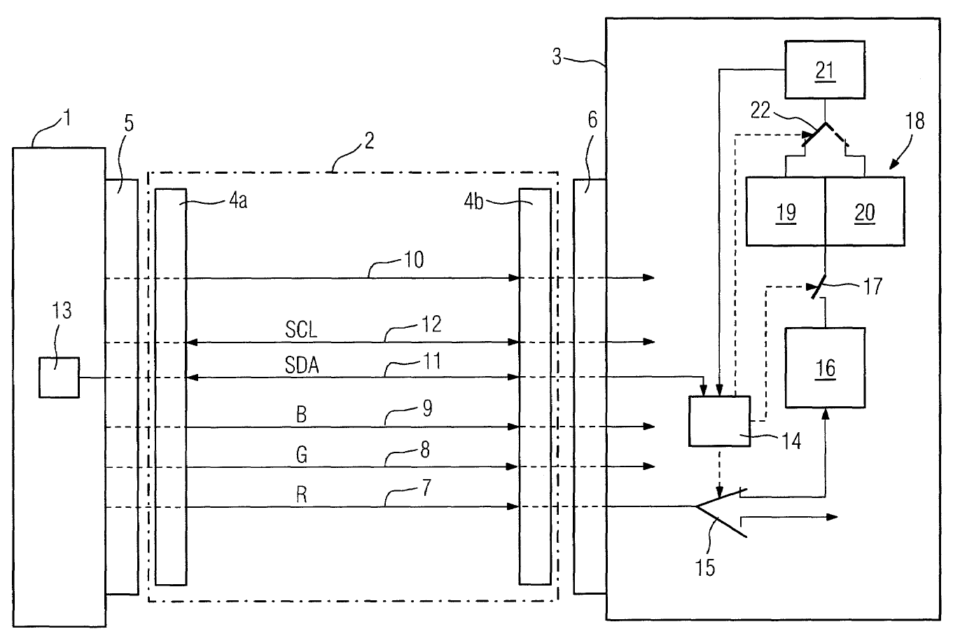

This is a Continuation of International Application PCT/EP2007/061929, with an international filing date of Nov. 6, 2007, which was published under PCT Article 21(2) in German, and the complete disclosure of which is incorporated into this application by reference.

### FIELD AND BACKGROUND OF THE INVENTION

The invention relates to an image playback system to which digital R, G, B video signals, respectively via R, G, B line pairs, and a communication signal are supplied by an image source. The system includes a program memory in which configuration data for a programmable module are stored, said data being necessary for operation of the image playback system.

The requirements placed on display quality in digital image playback systems, for example an image playback system in the form of an LCD display module or an LCD television set, are constantly increasing. In order to meet these requirements, a variety of corrections and/or adjustments are necessary, for example, correction of the image playback characteristic, by means of which a large quantity of data must be transferred to the image playback system. In addition, the demands made on the reliability and operational readiness of image playback systems are especially high, particularly for use in the medical field. For example, it has to be ensured that the firmware of an image playback system can be brought up to date (with a firmware update) both rapidly and without errors. In other words, it must be ensured that new configuration data necessary for operation of the image playback system, or their amended values, can be loaded into the system rapidly and error-free.

Conventionally, data are exchanged digitally between an image source, for example an image source in the form of a graphics card of a personal computer, and an LCD display module. The personal computer transfers digital R, G, B video signals to the LCD display module via a special DVI (digital video interface) cable which has a line pair for each of the R, G and B channels. This DVI cable also has further line pairs, in particular for transmitting a DVI clock signal and DDC (display data channel) data. The DDC line pair enables serial communication between the personal computer and the LCD display module, wherein via one data line in particular, specification information concerning the LCD display module, for example, information on data transfer rate, resolution of the LCD display, synchronization frequency and, via a clock line, a DDC clock signal, are transferred. The DDC line pair is often also used to transfer the data for adjusting the image playback characteristic to the LCD display module wherein, according to the 12C-BUS specification, the data transfer rate through this DDC line pair is only 100 kbit/sec. In other words, the data transfer takes up a great deal of time.

### OBJECT AND SUMMARY OF THE INVENTION

It is an object of the invention to provide an image playback system of the aforementioned type having improved firmware updating.

This object is achieved, according to one formulation, by an image playback system to which digital R, G, B video signals (R, G, B) and a communication signal (SDA) are supplied respectively via R, G, B line pairs, and a communication signal line, from an image source, comprising: a program memory storing configuration data of a programmable module that are required for operating the image playback system, wherein the communication signal is configured to indicate a transfer of current or updated configuration data, wherein the image playback system is configured to store the configuration data transferred from the image source via at least one line pair of the R, G, B line pairs in a data memory, and a controller configured to detect transfer errors in the configuration data and to load the configuration data stored in the data memory into the program memory only if the controller fails to detect any transfer errors.

It is advantageous if firmware updating does not have any disrupting effect on the operation of the system. Furthermore, a per se known and widely available DVI cable, which essentially is provided for the transfer of R, G, B video signals, can be used in order to transfer the configuration data and/or their amended values at a high data transfer rate from the image source to the image playback system. An additional cable is not required.

Before the current or updated configuration data are stored in the program memory, they are first checked for transfer errors. Only in the event that no transfer errors have been detected are the data stored in the program memory, thus completing updating of the firmware. The updated firmware is loaded into the programmable module, for example, a per se known FPGA module, during an initial phase following a system start-up.

In one embodiment of the invention, the program memory has a back-up memory region where configuration data that have previously been tested and are required for fault-free operation are stored. In the event that, on storage of the transferred data in a primary memory region of the program memory, an error or an error-laden region is detected in the programmable module, following a system start-up, the content of the back-up memory region is loaded into the programmable module.

Other embodiments of the invention are disclosed as well.

### BRIEF DESCRIPTION OF THE DRAWINGS

The invention will now be described in greater detail by reference to the single drawing, in which the FIGURE shows, in simplified form, an arrangement for transferring configuration data and/or their amended values.

### DETAILED DESCRIPTION OF PREFERRED EMBODIMENTS

An image source in the form of a personal computer 1 with a suitable graphics card is linked by means of a per se known DVI cable 2 to an image playback system in the form of an LCD display module 3. The DVI cable 2 has suitable connections 4a, 4b, the connections 4a being in operative connection electrically and mechanically with the connections 5 of the personal computer 1 and the connections 4b being in operative connection electrically and mechanically with the connections 6 of the LCD display module 3. By means of these connections 4a, 4b, 5, 6, which may be configured as per se known plugs and/or sockets corresponding thereto, and by means of the DVI cable 2, information is exchanged between the personal computer 1 and the LCD display module 3, this exchange being illustrated in the figure by interrupted and dashed lines.

The DVI cable 2 has three line pairs (channels) 7, 8, 9 for transferring digital R, G, B video signals and also has a further line pair 10 for transferring a DVI clock signal (DVI-Clock) at a first clock frequency of, for example, 165 MHz. The DVI cable 2 is also provided with a DDC (display data channel) display data line and a DDC clock line 11, 12, wherein conventionally, in a video operation mode, specification information SDA relating to the LCD display module, for example, information about the resolution of the LCD display or the synchronization frequency, are transferred via the display data line 11, and a DDC clock signal SCL, is transferred via the clock line 12 at a second clock frequency of 100 kHz.

The display data line 11 which, as described, is conventionally provided, in a video operation mode, as a communication line for transferring specification data, and the line pairs 7, 8, 9, which are conventionally provided in this video operation mode for transferring the R, G, B video signals, are used as described below, for transferring current or updated configuration data. For this purpose, a communication operating mode can be set in which the transfer of large amounts of data is provided for via at least one line pair 7 of the R, G, B line pairs 7, 8, 9.

In the interests of simplicity, it has been assumed in the exemplary embodiment that data are transferred via the line pair 7 only. In a practical embodiment of the invention, data are transferred through all three R, G, B video data channels and this results in an increased data transfer rate. A data transfer program 13 which can run on a personal computer 1 and which can naturally be part of a graphic processing program notifies a microcontroller 14, via the display data line 11, that in a subsequent data transfer cycle, it is not digital R, G, B video signals that will be transferred in a video operating mode, but that rather, in a communication operating mode, for example, configuration data will be transferred via the line pair 7. The microcontroller 14 acknowledges the notification to the data transfer program 13 and controls a first electronic switch 15 in such a way that the configuration data fed during the data transfer cycle from the personal computer 1 to the LCD display module 3 via the line pair 7 are not transferred to a video electronics system (shown only by way of an arrow output from the switch 15), but are written to a volatile data memory 16. In order to be able to check whether the configuration data have been correctly transferred, it is provided that the configuration data are transferred a plurality of times and that, following each transfer, the data are stored in a region of the data memory 16. In the event that the data are transferred, for example, three times, three regions are provided, of which a first region is intended for storage of the data transferred in a first transfer cycle, a second region is intended for storage of the data from a second cycle and the third region for that from a third cycle. The microcontroller 14 then compares the stored configuration data, for example, bit-wise or byte-wise. In the event that the compared configuration data match, the microcontroller 14 controls a second electronic switch 17 such that the configuration data stored in the first, second or third region of the data memory 16 are written into a primary memory region 19 of a program memory 18. Upon the next system start, the configuration data stored in this manner in the primary memory region 19 of the program memory 18 are loaded into a programmable module 21. In order to ensure that transfer errors are reliably identified, it is also provided that, aside from the actual configuration data, checksums are also transferred wherein, in each case, a pre-determined number of bytes to be transferred is secured with a checksum. In the event that the checking of these checksums by the microcontroller 14 indicates no errors, the configuration data stored in one region of the data memory 16 are transferred to the program memory 18.

The checksums stored in the program memory 18 are also used in a known manner to check the stored configuration data for errors. In the event that the microcontroller 14 identifies an error which indicates an error on storage of the configuration data in the primary memory region 19 of the program memory 18, the microcontroller 14 controls a third controllable switch 22 such that back-up configuration data stored in a back-up memory region 20 are loaded into the programmable module 21. These back-up configuration data represent previously tested configuration data which ensure fault-free operation, so that the functional capability of the LCD display module 3 is maintained even if faulty configuration data are stored in the primary memory region 19 of the program memory 18. Naturally, in place of the checksums transferred by the personal computer 1 and stored in the program memory 18, it is also possible to store in the program memory 18 checksums newly calculated by the microcontroller 14 and to use said checksums for checking fault-free storage of the configuration data. The microcontroller 14 is also configured to recognize faulty cells of sectors of the programmable module 21. During a system start-up, the microcontroller 14 loads the programmable module 21 with a test matrix and checks the cells of the module 21. In the event that the microcontroller 14 does not identify any errors, it programs the module 21 with the configuration data stored in the primary memory region 19 of the program memory 18. However, if the microcontroller 14 identifies an error in the programmable module 21, the microcontroller 14 transmits a signal to the personal computer 1, to display an error message on a display unit connected to the personal computer 1.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

What is claimed is:

1. An image playback system to which digital R, G, B video signals (R, G, B) and a communication signal (SDA) are supplied, respectively via R, G, B line pairs and a communication signal line, from an image source, comprising:
a program memory storing configuration data of a programmable module, which are required for operating the image playback system, wherein the communication signal is configured to indicate a transfer of current or updated configuration data, and wherein the image playback system is configured to store the configuration data transferred from the image source via at least one line pair of the R, G, B line pairs in a data memory, and
a controller configured to detect transfer errors in the configuration data and to load the configuration data stored in the data memory into the program memory only if the controller fails to detect any transfer errors.

2. The image playback system as claimed in claim 1, wherein the program memory comprises a primary memory region configured to store the configuration data loaded by the controller and a back-up memory region configured to store fault-free back-up configuration data, wherein the controller is configured to check the data stored in at least one of the primary memory region and regions of the programmable module and, in the event of an error, to program the programmable module with the back-up configuration data.

3. The image playback system as claimed in claim 1, wherein the controller is configured to notify the image source in the event of an error.

4. The image playback system as claimed in claim 1, further comprising a data switch configured to connect the at least one line pair of the R, G, B line pairs to the data memory in the event that the image source notifies the image playback system of the transfer of the current or updated configuration data.
